(19) United States
(12) Patent Application Publication
(10) Pub. No.: US 2022/0067305 A1
(43) Pub. Date: Mar. 3, 2022

(54) DOCUMENT MANAGEMENT APPARATUS, DOCUMENT MANAGEMENT SYSTEM, AND NON-TRANSITORY COMPUTER READABLE MEDIUM

(71) Applicant: FUJIFILM BUSINESS INNOVATION CORP., Tokyo (JP)

(72) Inventor: Tomoyuki SHIMIZU, Kanagawa (JP)

(73) Assignee: FUJIFILM BUSINESS INNOVATION CORP., Tokyo (JP)

(21) Appl. No.: 17/195,792

(22) Filed: Mar. 9, 2021

(30) Foreign Application Priority Data
Sep. 1, 2020 (JP) 2020-147018

(51) Int. Cl. G06F 40/42

(52) U.S. Cl. CPC G06F 40/42

(57) ABSTRACT

A document management apparatus includes a processor configured to provide a response to a user who is trying to obtain a first translation of a document by machine translation, wherein the processor is configured to vary the response to the user in a case where first settings set to obtain the first translation and second settings that have been used to obtain a second, previous translation of the document are different.

### CROSS-REFERENCE TO RELATED APPLICATIONS

This application is based on and claims priority under 35 USC 119 from Japanese Patent Application No. 2020-147018 filed Sep. 1, 2020.

### BACKGROUND

### (i) Technical Field

The present disclosure relates to a document management apparatus, a document management system, and a non-transitory computer readable medium.

### (ii) Related Art

There have been document management systems that translate a document and allow a user to view the translation result in accordance with an access right.

A translation proxy cache server that includes means for receiving an original hypertext markup language (HTML) document having a uniform resource locater (URL) specified by a browser from a World Wide Web (WWW) server, means for analyzing the original HTML document and extracting an object to be translated, and translation means for translating the object to generate a translated HTML document, wherein the translated HTML document is transmitted to the browser, is disclosed in Japanese Unexamined Patent Application Publication No. 2000-276431. The browser includes means for instructing the server on the URL of a desired HTML document.

A machine translation system is disclosed in Japanese Unexamined Patent Application Publication No. 2008-26971. The machine translation system includes a dictionary unit that stores language information including at least a headword in a first language and a translated word in a second language, a translation unit that translates a document in the first language whose content is updated regularly or irregularly into the second language under one or more translation environments, a translation result accumulation unit that accumulates results of translation performed by the translation unit under the one or more translation environments and reads and outputs a result of translation in a case where translation of the document in the first language under a specified translation environment is requested by the user, a statistics database that stores the number of times that a result of translation has been read by the translation result accumulation unit as the number of translation times for each translation environment, and a controller that instructs the translation unit to translate an updated document in the first language by providing priority to translation under a translation environment with a more number of translation times stored in the statistics database.

### SUMMARY

When a user is trying to translate a document, the document may have already been translated. In such a case, the user does not need to translate the document again. However, the user may not have an access right to the translated document. Thus, allowing the user who does not have the access right to view the translated document may cause a security problem.

Aspects of non-limiting embodiments of the present disclosure relate to providing a document management apparatus and so on that take into consideration an access right of a user, and at the same time, helps the user to avoid translating the same document a plurality of times.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a document management apparatus including a processor configured to provide a response to a user who is trying to obtain a first translation of a document, wherein the processor is configured to vary the response to the user in a case where first settings set to obtain the first translation and second settings that have been used to obtain a second, previous translation of the document are different.

### BRIEF DESCRIPTION OF THE DRAWINGS

Exemplary embodiments of the present disclosure will be described in detail based on the following figures, wherein:

FIG. 1 is a diagram illustrating an example of a configuration of a document management system according to an exemplary embodiment;

FIG. 2 is a block diagram for explaining an example of a functional configuration of a document management server;

FIG. 3 is a flowchart of a process performed by the document management system;

FIG. 4 is a diagram illustrating a dialog for allowing a user to perform settings for translation in step 102 illustrated in FIG. 3;

FIG. 5 is a diagram illustrating a translation completion notification;

FIG. 6 is a diagram illustrating a dialog for performing settings for an access right;

FIG. 7 is a diagram illustrating an example of a notification provided to a user;

FIG. 8 is a diagram illustrating a dialog for document version management;

FIGS. 9A and 9B are diagrams illustrating examples of a notification provided to a user;

FIGS. 10A, 10B, and 10C are diagrams illustrating a notification of a request for an access right;

FIG. 11 is a diagram illustrating a setting screen for a case where an original (initial version) is separated out and a user is granted an access right to only the original (initial version), which is explained in FIG. 10B;

FIGS. 12A, 12B, and 12C are diagrams illustrating data structures of various data stored in the storing unit;

FIGS. 13A, 13B, and 13C are diagrams illustrating data structures of various data stored in the storing unit; and

FIGS. 14A and 14B are diagrams illustrating a notification provided to a user when translation is being performed.

### DETAILED DESCRIPTION

<Explanation for Entire Document Management System>

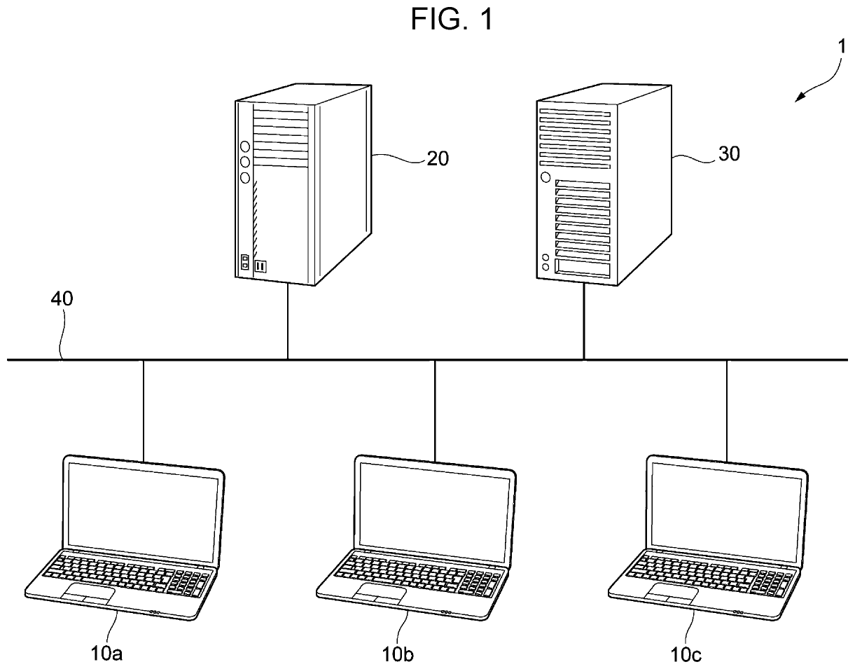

FIG. 1 is a diagram illustrating an example of a configuration of a document management system 1 according to an exemplary embodiment.

The document management system 1 illustrated in FIG. 1 includes terminal apparatuses 10a, 10b, and 10c, which are also referred to as terminal apparatuses 10, a document management server 20, and a translation server 30 that are connected to one another via a network 40.

In FIG. 1, the three terminal apparatuses 10a, 10b, and 10c are illustrated. However, the number of terminal apparatuses 10 provided is not limited to three as long as a plurality of terminal apparatuses 10 are provided. Hereinafter, the terminal apparatuses 10a, 10b, and 10c may be simply represented by the terminal apparatuses 10 in the case where the terminal apparatuses 10a, 10b, and 10c are not distinguished from one another.

In FIG. 1, the document management system 1 is, for example, a system that manages translation of documents.

In an exemplary embodiment, a “document” is an electronic document obtained by digitizing character information and/or image information. The format, data structure, and the like of an electronic document are not particularly limited as long as the electronic document is able to be handled by each of the terminal apparatuses 10, the document management server 20, and the translation server 30. In an exemplary embodiment, a document is, for example, a form. Specific examples of a form include a quotation, an invoice, a detailed report, an approval document, and an application form.

The terminal apparatuses 10 each display a document in accordance with an operation performed by a user, and the user uses the terminal apparatus 10 to view the document. When the user needs a translation of the document, the user requests the document management server 20 for a translation of the document. A user who requests the translation of the document may be hereinafter referred to as a “user B”. The terminal apparatuses 10 are, for example, computer devices such as a general-purpose personal computer (PC), a mobile computer, a mobile phone, a smartphone, and a tablet. The terminal apparatuses 10 each operate various types of application software under the management of an operating system (OS) to process a document managed by the document management server 20.

The document management server 20 is an example of a document management apparatus that manages a document and is a server computer that manages a document. For example, the document management server 20 performs authentication of a user who operates a terminal apparatus 10 and transmits a document to the terminal apparatus 10 so that the document is processed in each process. The document management server 20 also receives a document processed by the user from the terminal apparatus 10, and stores the received document. Furthermore, when receiving a request for a translation of a document from the terminal apparatus 10, the document management server 20 causes the translation server 30 to translate the document and transmits the translation of the document back to the terminal apparatus 10.

The translation server 30 is a server computer that machine-translates a document. The translation server 30 machine-translates a document written in a first language into a second language that is different from the first language. A “language” is a natural language. “Machine translation” represents conversion such as translation from a natural language into another natural language using a computer. Non-limiting examples of a language include Japanese and English. The translation server 30 may be a cloud server that provides a machine translation service on a cloud environment. In this example, the document management server 20 and the translation server 30 are provided separately. However, a single server computer may implement both the functions of the document management server 20 and the translation server 30.

The terminal apparatuses 10, the document management server 20, and the translation server 30 each include a central processing unit (CPU) as arithmetic means, a main memory as storing means, and storages such as a hard disk drive (HDD) and a solid state drive (SSD). In this example, a CPU is an example of a processor and executes various types of software such as OS (basic software) and application software. Furthermore, the main memory is a memory region in which various types of software, data to be used for execution of the various types of software, and the like are stored. The storage is a memory region in which data input to various types of software, data output from various types of software, and the like are stored.

Furthermore, the terminal apparatuses 10, the document management server 20, and the translation server 30 each include a communication interface (hereinafter, written as a “communication I/F”) for performing communication with the outside, a display mechanism including a video memory, a display, and the like, and an input device such as a keyboard, a mouse, and a touch panel.

The network 40 is communication means used for information communication between the terminal apparatuses 10, the document management server 20, and the translation server 30 and is, for example, the Internet, a local area network (LAN), or a wide area network (WAN). A communication line used for data communication may be wired or wireless and may be a combination of wired network and wireless network. Furthermore, the terminal apparatuses 10, the document management server 20, and the translation server 30 may be connected via a plurality of networks or communication lines using a gateway device or a relay device such as a router.

### <Explanation for Functional Configuration of Document Management Server>

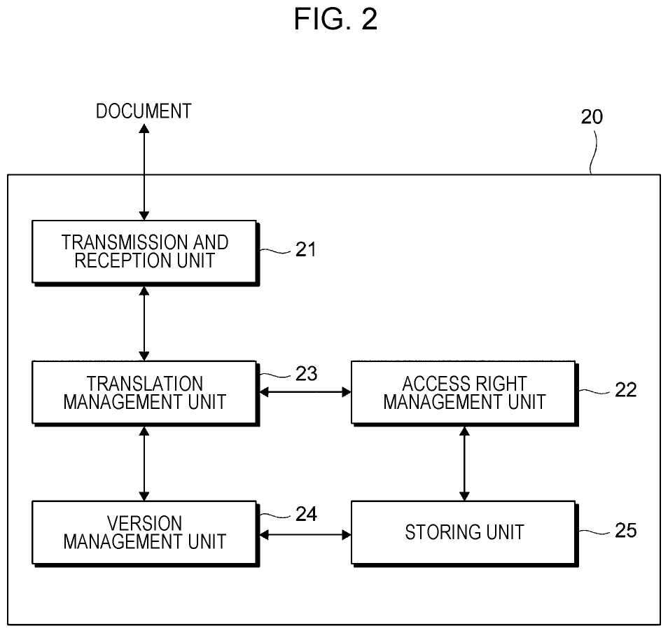

FIG. 2 is a block diagram for explaining an example of a functional configuration of the document management server 20.

In FIG. 2, only part of various functions of the document management server 20 that is relevant to this exemplary embodiment is selected and illustrated.

The document management server 20 illustrated in FIG. 2 includes a transmission and reception unit 21 that performs transmission and reception of a document, an access right management unit 22 that manages an access right of a user, a translation management unit 23 that manages translation of documents, a version management unit 24 that performs version management of documents, and a storing unit 25 that stores a document.

The transmission and reception unit 21 performs transmission and reception of a document to and from the terminal apparatuses 10 via the network 40. The transmission and reception unit 21 corresponds to, for example, the communication I/F.

The access right management unit 22 performs authentication of a user who operates a terminal apparatus 10. The access right management unit 22 also manages access rights of the user to access different documents. Furthermore, the access right management unit 22 sets confidentiality level of each document and manages the confidentiality level. In this example, “confidentiality level” represents the degree of secrecy with respect to content of the document.

The translation management unit 23 manages translation of documents as a whole. Specifically, when receiving a translation request of a document from a user, the translation management unit 23 determines whether or not the document has previously been translated. The translation management unit 23 also receives translation settings set by a user. Furthermore, the translation management unit 23 requests the translation server 30 to translate a document.

In a case where a translation is edited, the version management unit 24 performs version management to track changes made to the translation. “Edits” include, for example, human corrections that are made to increase quality of a translation obtained by machine translation.

The access right management unit 22, the translation management unit 23, and the version management unit 24 correspond to, for example, a CPU.

The storing unit 25 stores a source document and a target document. The target document is a translation of the source document. The storing unit 25 also stores settings for document versions, settings for access rights of users, and the like. An example of the storing unit 25 is a storage.

### <Explanation for Process Performed by Document Management System>

Next, a process performed by the document management system 1 will be described.

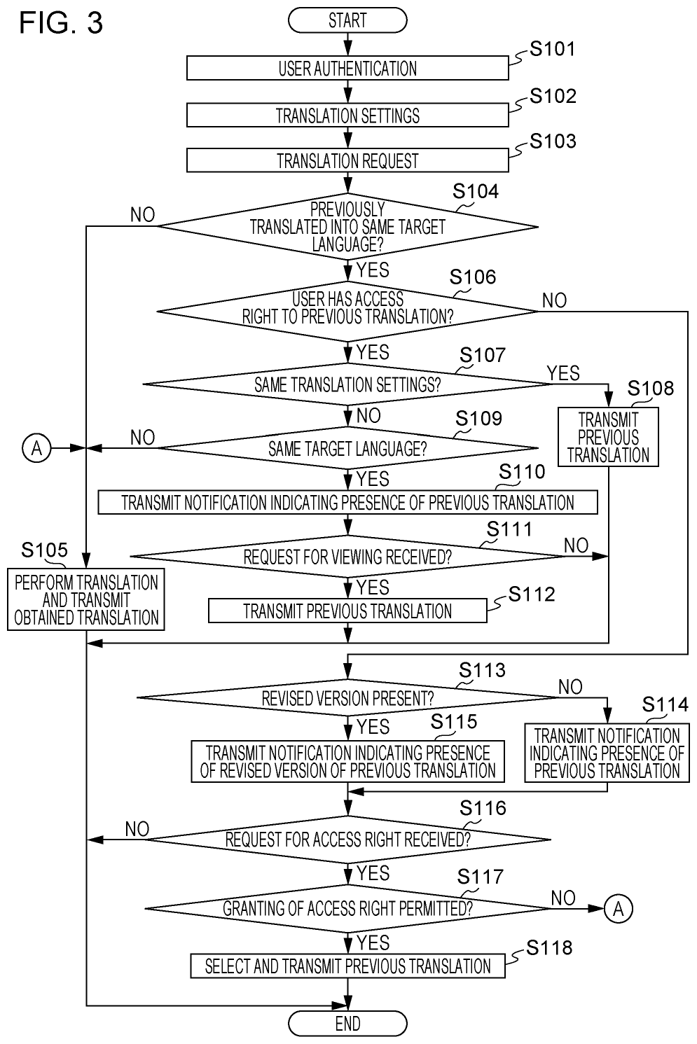

FIG. 3 is a flowchart of a process performed by the document management system 1.

First, the document management server 20 performs authentication of the user B of a terminal apparatus 10 (step 101). Authentication of the user B is performed by the access right management unit 22.

Next, the user B selects a document of which he/she wants a translation and performs settings for the translation (step 102).

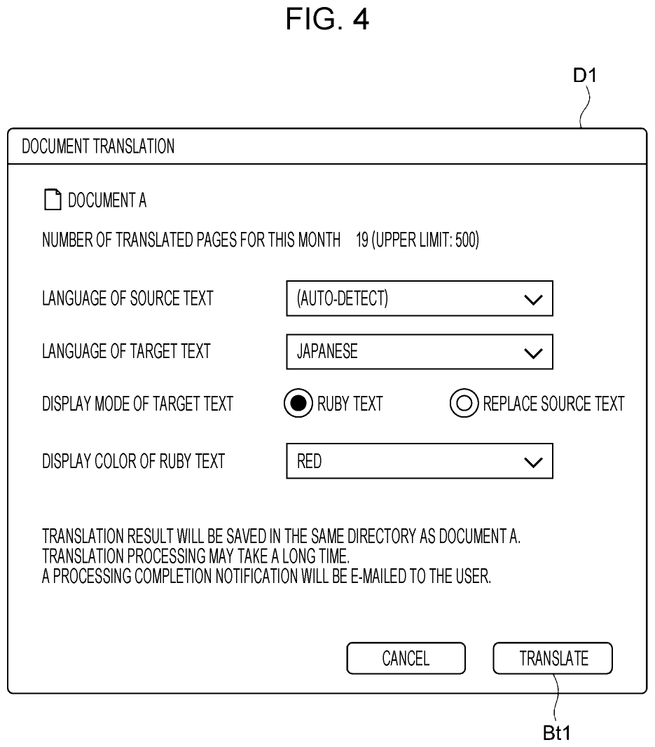

FIG. 4 is a diagram illustrating a dialog D1 for allowing the user B to perform the settings for the translation in step 102 in FIG. 3.

With the dialog D1 illustrated in FIG. 4, the user B is allowed to set a language of source text, a language of target text, a display mode of the target text, and a display color of ruby text (annotations). The “language of source text” refers to the language in which the source document is written. The “language of target text” refers to the language into which the source text is to be translated (the language of the target document). As a “display mode of target text”, “ruby text” or “replace source text” may be selected. When “ruby text” is selected, the target document will have the source text, plus the target text as ruby (annotative) text to the source text. That is, the document obtained as a result of the translation will have both the source text and the target text. When “replace source text” is selected, the source text will be replaced by the target text, and only the target text will be presented in the target document. That is, the document obtained as a result of the translation will not include the source text but only the target text. When “ruby text” is selected as the display mode of the target text, a display color of the ruby text may be specified by “display color of ruby text”. When “red” is selected as illustrated in FIG. 4, the target document will present the source text in, for example, black and the target text in red.

In the case of FIG. 4, the user B specifies at least the language of the target text. When the user B selects a translate button Bt1, the translation request is transmitted to the document management server 20. The selecting of the button is performed by, for example, a predetermined operation such as clicking with an input device such as a mouse.

Referring back to FIG. 3, the user B transmits the translation request to the document management server 20, and the translation management unit 23 of the document management server 20 receives the translation request via the transmission and reception unit 21 (step 103).

Then, the translation management unit 23 determines whether or not the document for which a translation is being requested has previously been translated into the same language of the target text specified by the user B (step 104).

In the case where it is determined that the document has never been translated into the same language of the target text specified by the user B (No in step 104), the translation management unit 23 requests the translation server 30 to newly translate the document with the settings that have been specified by the user B, and then transmits the translation back to the terminal apparatus 10 (step 105). At this time, the translation management unit 23 transmits a translation completion notification indicating completion of the translation to the user B. Accordingly, the translation of the document becomes viewable by the user B on the terminal apparatus 10.

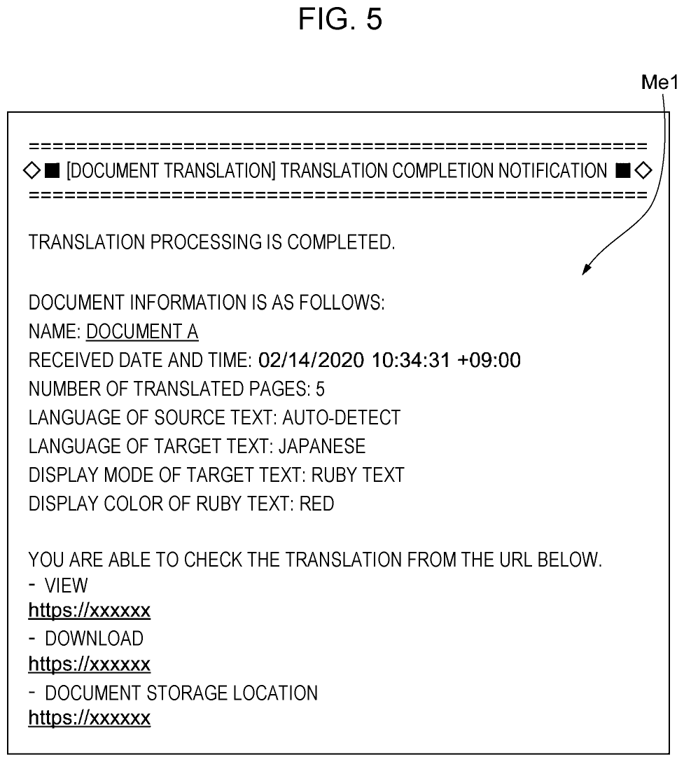

FIG. 5 is a diagram illustrating an example of the translation completion notification.

In this case, the translation completion notification is text of an e-mail transmitted to the user B. As illustrated in FIG. 5, a message Me1 indicating that the translation of the document is complete is displayed. Furthermore, information of the document, a URL for viewing the translation, a URL for downloading the translation, and a URL of a storage location of the translation are also displayed below the message Me1.

In contrast, in the case where it is determined in step 104 in FIG. 3 that the document has previously been translated into the same language of the target text specified by the user B (Yes in step 104), the access right management unit 22 determines whether or not the user B who has requested translation has the access right to the previous translation (step 106).

In the case where it is determined that the user B has the access right (Yes in step 106), the translation management unit 23 determines whether or not the settings used to obtain the previous translation and the settings that have been set by the user B in step 102 are the same (step 107).

In the case where it is determined that the settings used to obtain the previous translation and the settings that have been set by the user B in step 102 are the same (Yes in step 107), the translation management unit 23 transmits the previous translation to the terminal apparatus 10 via the transmission and reception unit 21, and the previous translation is presented to the user B (step 108). That is, in this exemplary embodiment, in the case where the user B has the access right to the previous translation and the settings that have been set by the user B and the settings used to obtain the previous translation of the document are the same, the previous translation of the document is displayed.

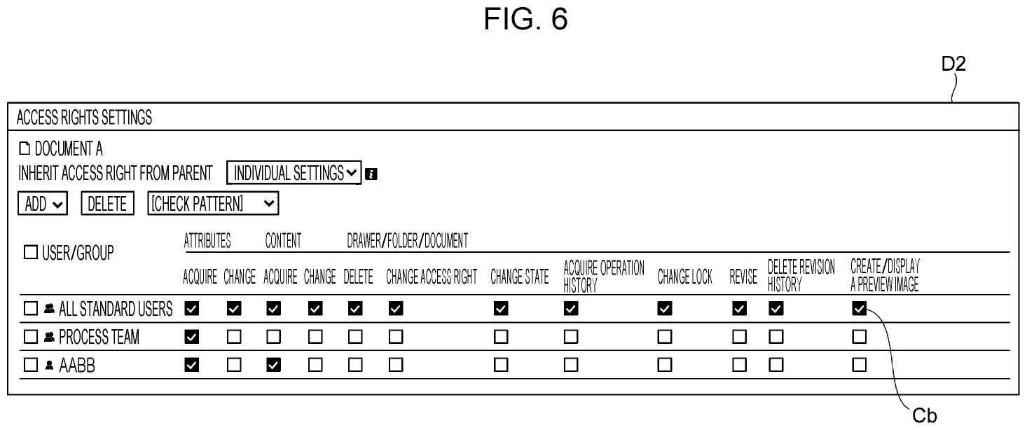

FIG. 6 is a diagram illustrating a dialog D2 for access right settings.

The access rights are set, for example, by an administrator of the document management server 20.

Here, the access rights to a document are set for each user or group by ticking or not ticking check boxes Cb that indicate acquisition permissions, editing permissions, etc. In FIG. 6, “AABB” represents the name of the user.

In contrast, in the case where it is determined in step 107 in FIG. 3 that the settings used to obtain the previous translation and the settings that have been set by the user B in step 102 are different (No in step 107), the translation management unit 23 determines whether or not the language of the previous translation (the setting of the language of the target text used to obtain the previous translation) and the setting of the language of the target text that has been specified by the user B are the same among other settings (step 109).

In the case where the language of the previous translation and the setting of the language of the target text that has been specified by the user B are the same (Yes in step 109), the translation management unit 23 notifies the user B of presence of the previous translation of the document (step 110). That is, in this exemplary embodiment, in the case where the user B has the access right to the previous translation, the settings that have been set by the user B and the settings that were used to obtain the previous translation are not exactly the same, and the language of the previous translation and the setting of the language of the target text that has been specified by the user B are the same, the user B is notified of presence of a previous translation obtained with different settings.

In contrast, in the case where the language of the previous translation and the setting of the language of the target text that has been specified by the user B are different (No in step 109), the process proceeds to step 105, and the document is newly translated with the settings that have been specified by the user B.

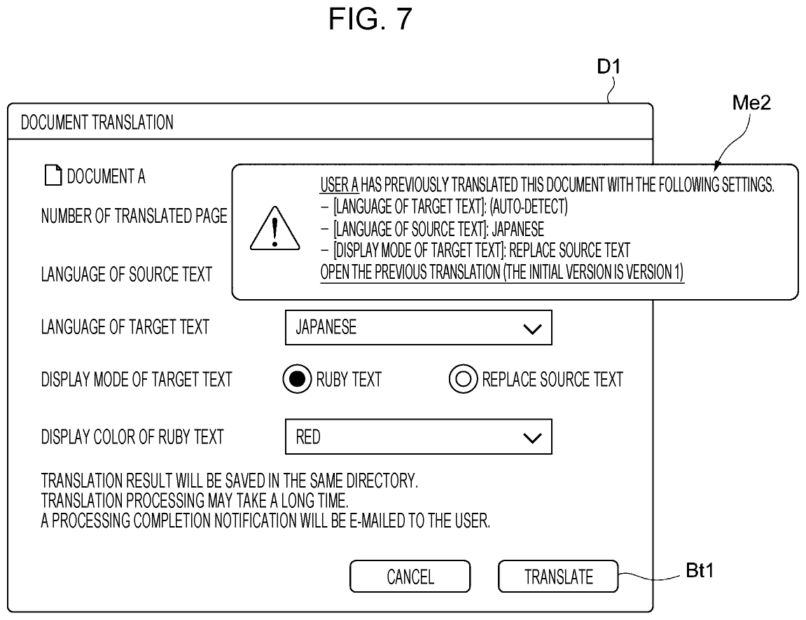

FIG. 7 is a diagram illustrating an example of a notification provided to the user B in such case.

In this example, the notification is displayed as a message Me2 on the terminal apparatus 10. In this example, the message Me2 is displayed over the dialog D1 illustrated in FIG. 4.

The message Me2 informs the user B that a user A who is different from the user B has previously translated the same document and presents the settings used by the user A when the document was previously translated by the user A. The user B views the message Me2. When the user B selects “Open the previous translation (the original version is Version 1).”, the previous translation obtained with the settings set by the user A is displayed. Even though the settings of the previous translation of the document are not the same as the settings that have been set by the user B in step 102, the user B may benefit from the previous translation when the user B does not mind differences in the settings or when the user B simply wants to view the previous translation of the document.

As explained above regarding steps 108 and 110, in the case where the document has previously been translated at the time when the user B is trying to machine-translate the document, the translation management unit 23 provides the user B with different responses in accordance with differences in the settings that were used to obtain the previous translation and the settings that have been set by the user B in step 102.

After the notification in step 110 in FIG. 3, the translation management unit 23 determines whether or not a request for viewing the previous translation is received from the user B (step 111).

In the case where a request for viewing the previous translation is received (Yes in step 111), the translation management unit 23 transmits the previous translation to the terminal apparatus 10 (step 112). This processing corresponds to the case where the user selects “Open the previous translation (the original version is Version 1).”, as explained with reference to FIG. 7, and the previous translation that was obtained with different settings from the settings that have been set by the user B is displayed.

In contrast, in the case where a request for viewing the previous translation is not received (No in step 111), the process ends.

In contrast, in the case where it is determined in step 106 that the user does not have the access right to the previous translation (No in step 106), the version management unit 24 determines whether or not a revised version of the previous translation is present (step 113).

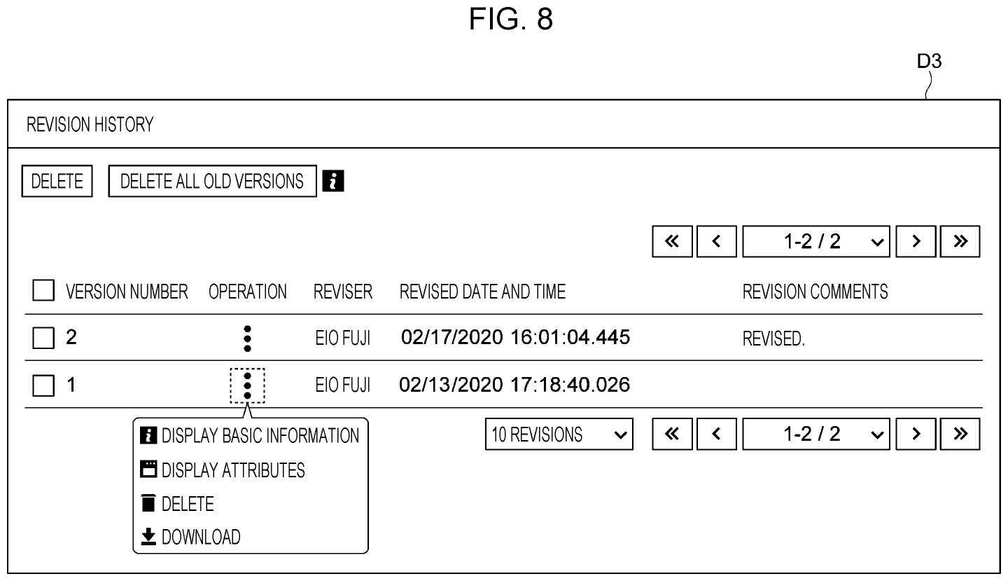

FIG. 8 is a diagram illustrating a dialog D3 for document version management.

The dialog D3 displays history of revisions. FIG. 8 illustrates an example case where an original created by Eio Fuji has been revised once by Eio Fuji. The original (Version 1) may be an original machine translation output by the translation server 30. The revised version (Version 2) may be a revised version of the original machine translation revised by Eio Fuji. The dialog D3 displays basic information, attributes, and options such as deletion and downloading for the original (Version 1) and the revised version.

In the case where it is determined in step 113 in FIG. 3 that no revised version is present (No in step 113), the translation management unit 23 notifies the user B of presence of the previous translation (step 114). In this processing, the user B may request the access right for viewing the previous translation.

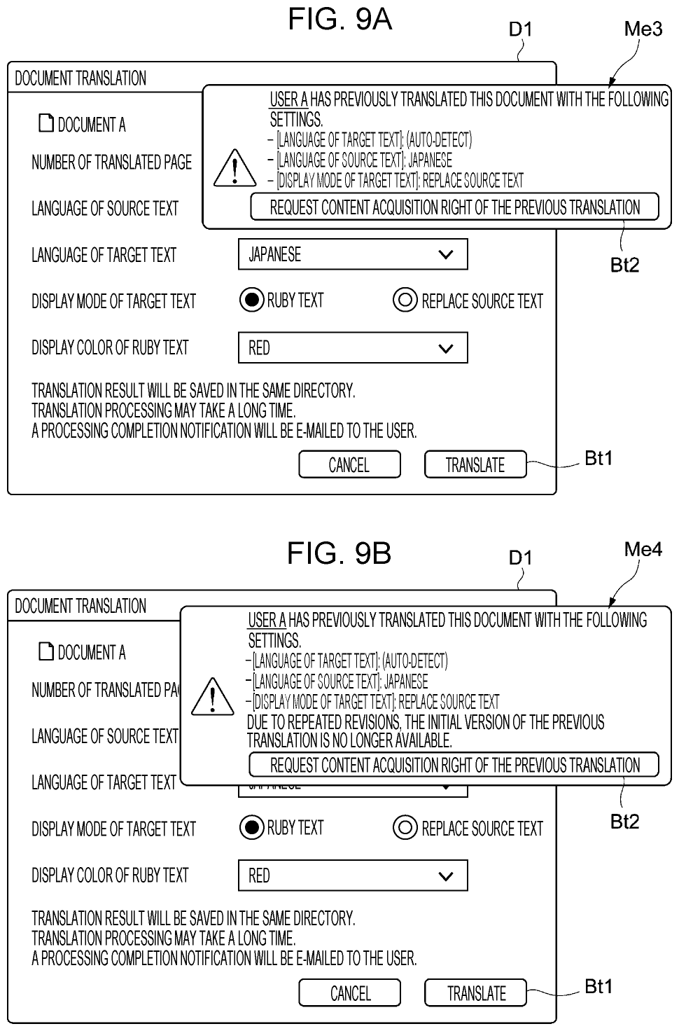

FIG. 9A is a diagram illustrating an example of a notification provided to the user B in step 114 in FIG. 3.

In this case, the notification is displayed as a message Me3 on the terminal apparatus 10. In the example illustrated in FIG. 9A, the message Me3 is displayed over the dialog D1 illustrated in FIG. 4.

The message Me3 informs the user B that the user A who is different from the user B has previously translated the same document and presents the settings used by the user A when the document was previously translated by the user A. A button Bt2 “Request content acquisition right of the previous translation” is also displayed. By selecting the button Bt2, the user may request the access right to the previous translation.

In contrast, in the case where it is determined in step 113 in FIG. 3 that a revised version of the previous translation is present (Yes in step 113), the translation management unit 23 notifies the user B of presence of the previous translation and presence of a revised version of the previous translation (step 115). The user B may request the access right for viewing the previous translation.

FIG. 9B is a diagram illustrating an example of a notification provided to the user B in step 115 in FIG. 3.

In this case, the notification is displayed as a message Me4 on the terminal apparatus 10. In the example illustrated in FIG. 9B, the message Me4 is displayed over the dialog D1 illustrated in FIG. 4.

In addition to the information presented by the message Me3 illustrated in FIG. 9A, the message Me4 provides information about the revised version of the previous translation. In this case, the notification indicates that although a revised version of the previous translation is present, due to repeated revisions, the original (Version 1) of the previous translation is no longer available. That is, the version management unit 24 may set the maximum number of versions to store for version management. Thus, as newer versions of a document are saved, older versions of the document may be deleted. In such case, the original (Version 1) of the previous translation may not be available. Here, the original (Version 1) of the previous translation is the initial translation output by the translation server 30. The message Me4 may indicate which revised version remains. As described above, in the case where the initial version of the previous translation is not available, the translation management unit 23 notifies the user of the non-availability of the initial version of the previous translation.

The button Bt2 “Request content acquisition right of the previous translation” is also displayed. By selecting the button Bt2, the user requests the access right for viewing the previous translation.

The request for the access right from the user B is received by the translation management unit 23.

That is, in this case, in the case where the user B does not have the access right to the previous translation, the translation management unit 23 waits to receive the request for the access right from the user B. When the request is received from the user B, the translation management unit 23 transmits the request from the user B to, for example, an administrator of the document management server 20.

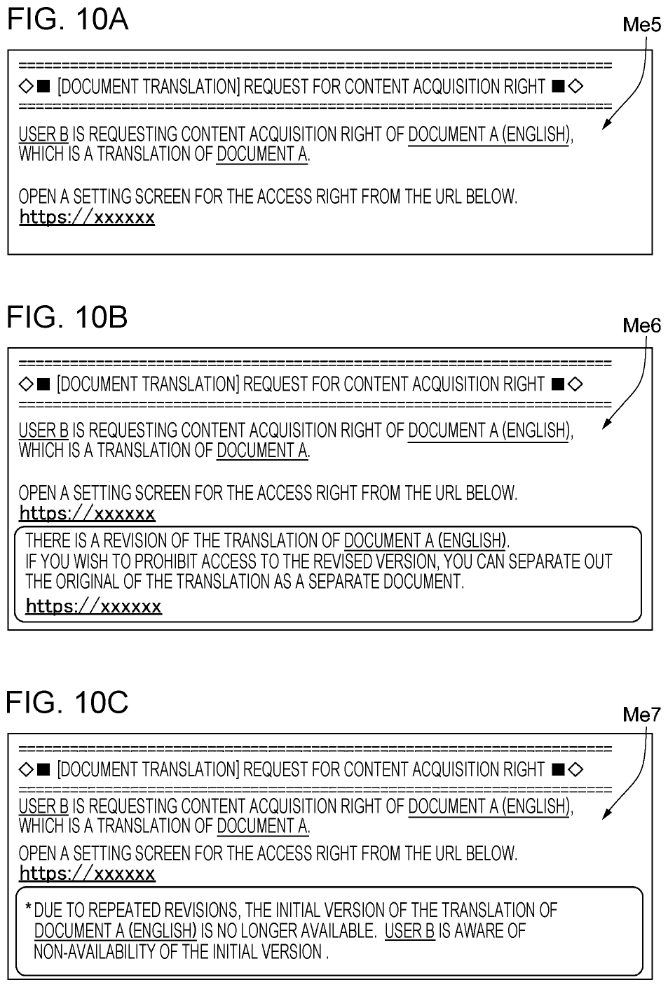

FIGS. 10A to 10C are diagrams illustrating a notification of a request for the access right.

This notification represents text of an e-mail transmitted to the administrator of the document management server 20.

FIG. 10A illustrates text of an e-mail transmitted to the administrator when the user B requests the access right in the case where there is no revised version of the previous translation. That is, FIG. 10A illustrates text of an e-mail transmitted to the administrator when the user B requests the access right in response to the notification illustrated in FIG. 9A.

In this case, a message Me5 indicating that the user B has requested the access right to the translated document A is displayed. The administrator grants the access right to the user B from a URL provided in the e-mail.

FIGS. 10B and 10C illustrate text of an e-mail transmitted to the administrator when the user B requests the access right in response to a notification provided in the case where there is a revised version of the previous translation.

FIG. 10B illustrates text of an e-mail transmitted when the user B requests the access right in the case where there is a revised version of the previous translation and the original (initial version) of the previous translation is still also available.

As illustrated in FIG. 10B, a message Me6 includes information indicating that a revised version is present in addition to the text illustrated in FIG. 10A is displayed. FIG. 10B further includes a message which informs that the administrator may separate out the original (initial version) of the previous translation and grant the user B the access right to only permit access to the original of the previous translation if the administrator wants to prohibit the user B from accessing the revised version(s) of the previous translation. That is, the quality of translation often improves in revised versions, and the confidentiality level may increase as the quality of translation improves. Thus, there may be some cases where the administrator is OK with the user B accessing the original (initial version) but is not OK with the user B accessing the revised version(s). Setting access rights to individual versions separately requires complicated processing and may not be so convenient. Thus, the original (initial version) may be separated out so that the access right may be set to only permit access to the original (initial version) among other versions for the user B. In this case, when the URL in the lowermost part of the message Me6 is selected, a setting screen for granting the user B the access right to only permit access to the original version is displayed.

FIG. 10C illustrates text of an e-mail transmitted to the administrator when the user B requests the access right in the case where a revised version of the previous translation is present but the original (initial version) of the previous translation is not available. That is, FIG. 10C illustrates text of an e-mail transmitted to the administrator when the user B requests the access right in response to the notification illustrated in FIG. 9B.

As illustrated in FIG. 10C, a message Me1 includes a message informing that the original (initial version) of the previous translation is not available in addition to the text illustrated in FIG. 10A.

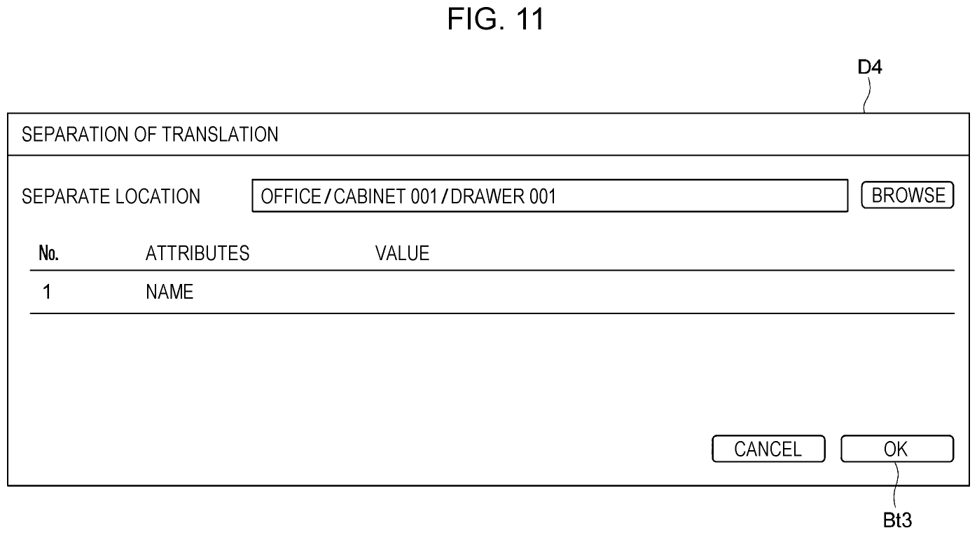

FIG. 11 is a diagram illustrating a setting screen displayed for the case where the administrator wants to separate out the original (initial version) to grant the user B the access right to only permit access to the original (initial version) among other versions, as explained above with reference to FIG. 10B.

A dialog D4 is displayed as the setting screen. In the dialog D4, a location to save the original (initial version) is set as a separate location. In the case where the administrator wants to name the original differently, the administrator may enter the new name in the name field. When an OK button Bt3 in the dialog D4 is selected, the original (initial version) is saved to the set separate location.

Referring back to FIG. 3, the translation management unit 23 determines whether or not a request for the access right is received from the user B in response to the notification in step 114 or 115 (step 116).

In the case where it is determined that no request for the access right is received (No in step 116), the process ends.

In contrast, in the case where it is determined that a request for the access right is received (Yes in step 116), the translation management unit 23 determines whether or not granting of the access right is permitted by the administrator (step 117).

In the case where it is determined that granting of the access right is not permitted (No in step 117), the process proceeds to step 105. That is, translation of the document is performed again.

In contrast, in the case where it is determined that granting of the access right is permitted (Yes in step 117), the translation management unit 23 selects a previous translation to be transmitted to the user B, and transmits the selected previous translation (step 118).

In this case, in the case where no revised version is present as illustrated in FIG. 10A, the original version is transmitted to the user B.

In the case where a revised version is present and the original (initial version) is also available as illustrated in FIG. 10B, the administrator may permit access to all the versions or may separate out the original (initial version) and permit access only to the original (initial version) as illustrated in FIG. 11. Furthermore, in the case where the original (initial version) is not available as illustrated in FIG. 10C, access to an available version or available versions is permitted. As described above, the translation management unit 23 sets a version or versions to which the user can access with the access right. The translation management unit 23 may grant the user the access right to permit access to all versions of the previous translation. The translation management unit 23 may separate out the initial version (original) of the previous translation and grant the user the access right to only permit access to the initial version of the previous translation.

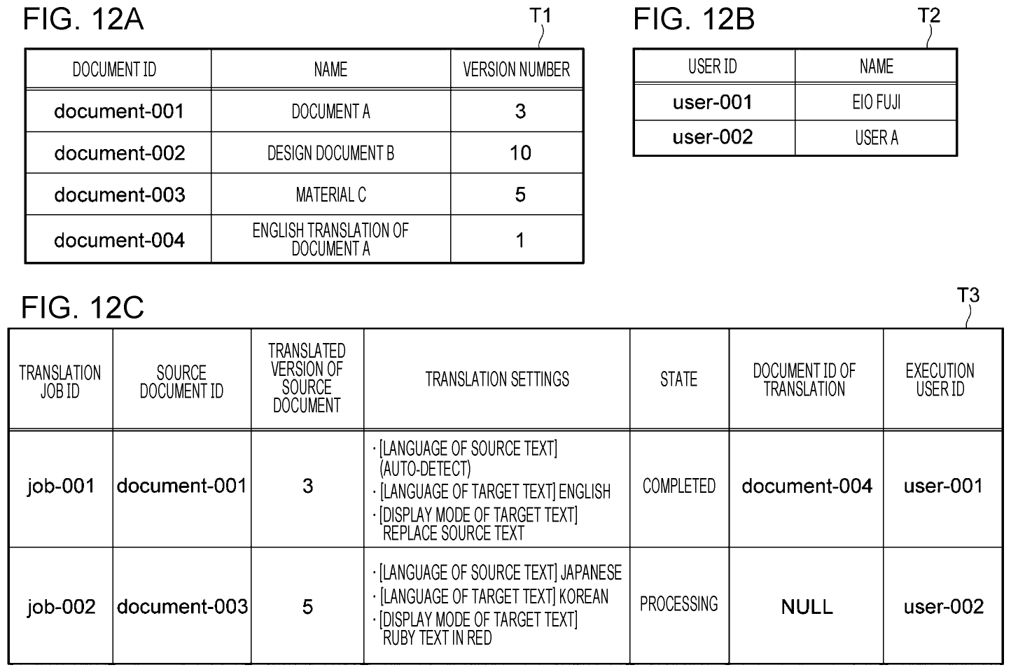

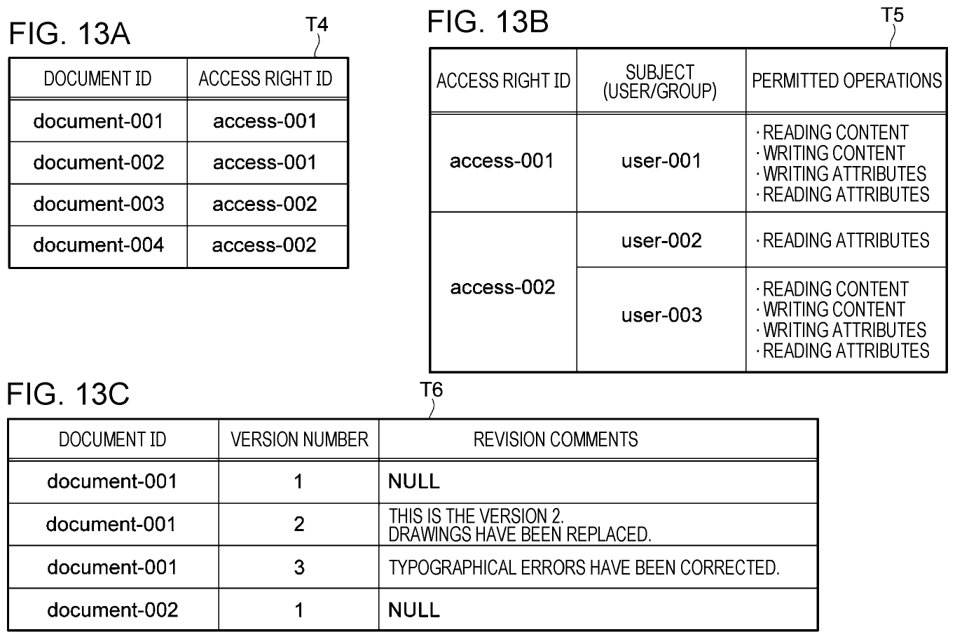

FIGS. 12A to 12C and FIGS. 13A to 13C are diagrams illustrating data structures of various data stored in the storing unit 25.

FIG. 12A illustrates a data structure of document data. Document data is stored as a document table T1 in the storing unit 25. The document table T1 stores the document ID for identifying each document in association with the name of the document and the revision number (version) of the document.

FIG. 12B illustrates a data structure of user data. User data is stored as a user table T2 in the storing unit 25. The user table T2 stores the user ID of each user in association with the name of the user.

FIG. 12C illustrates a data structure of translation job data. A translation job is created when a document is translated upon a translation request by the user B. Translation job data is stored as a translation job table T3 in the storing unit 25. The translation job table T3 stores the translation job ID for each translation job (translation job number) in association with the ID of the source document of the translation job, the version number of the source document translated by the translation job, the translation settings used for the translation job, the state of the translation job, the document ID of the translation obtained by the translation job (the ID of the target document of the translation job), and the translation execution user ID (the ID of the user B who has requested the translation).

FIG. 13A illustrates a data structure of document access rights. The document access rights are stored as a document access right table T4 in the storing unit 25. The document access right table T4 stores the document ID for identifying each document in association with the access right ID for identifying the access right to the document.

FIG. 13B illustrates a data structure of access right settings. The settings of each access right are stored as an access right table T5 in the storing unit 25. The access right table T4 stores the access right ID of each access right in association with the subject (user/group) to which the access right is granted, and the permitted operation(s) permitted by the access right. That is, the settings of the access rights illustrated in FIG. 13A are written in the access right table T5.

FIG. 13C illustrates a data structure of document version data. Document version data is stored as a document version table T6 in the storing unit 25. The document version table T6 stores the document ID of each document in association with a version number of the document and the revision comments by the reviser.

### MODIFICATIONS

Modifications will be described below.

### Modification 1: Document is Undergoing Translation Process

The exemplary embodiments so far have illustrated a case where the translation of the document requested by the user A (the previous translation) is already complete when the user B is trying to machine-translate the document. However, there may be a case where translation process to obtain the translation requested by the user A is still in progress. That is, the translation of the document has been requested by the user A but not yet been obtained. In the case where the document is still being machine-translated to obtain the translation requested by the user A when the user B is trying to request another machine-translation of the document, the user is notified that the document is undergoing machine translation process to obtain the translation requested by the user A.

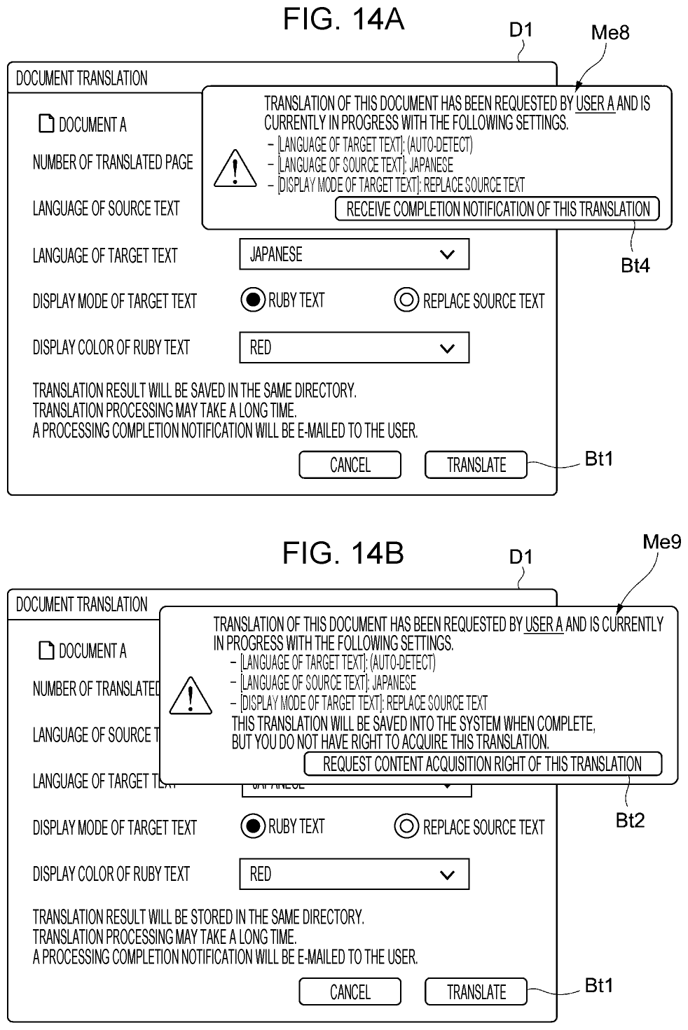

FIGS. 14A to 14B are diagrams illustrating a notification provided to the user B when the translation process to obtain the previous translation is in progress at the time the user B is trying to machine-translate the document.

FIG. 14A illustrates a notification provided in a case where the user has an access right to the translation requested by the user A. The notification illustrated in FIG. 14 corresponds to, for example, a notification provided in place of the notification illustrated in FIG. 7.

The notification illustrated in FIG. 14 is displayed as a message Me8 on the terminal apparatus 10. In the example illustrated in FIG. 14A, the message Me8 is displayed over the dialog D1 illustrated in FIG. 4.

The message Me8 informs the user B that the user A who is different from the user B is machine-translating the same document and presents the settings that are being used by the user A. A button Bt4 “Receive completion notification of this translation (the translation requested by the user A)” is also displayed. If the button Bt4 is selected, the translation management unit 23 notifies the user B of completion of the translation by the user A when the machine translation by the user A is completed.

FIG. 14B illustrates a notification provided in a case where the user does not have an access right to the translation requested by the user A. The notification illustrated in FIG. 14B corresponds to, for example, a notification provided in place of the notification illustrated in FIG. 9A.

The notification illustrated in FIG. 14B is displayed as a message Me9 on the terminal apparatus 10. In the example illustrated in FIG. 14B, the message Me9 is displayed over the dialog D1 illustrated in FIG. 4.

In the message Me9, a message indicating that the user B does not have an access right to the previous translation is added to the message Me8 illustrated in FIG. 14A.

The button Bt2 “Request content acquisition right of this translation” is also displayed. The button Bt2 allows the user B to request an access right which permits the user B to view the translation requested by the user A (the previous translation) when the translation requested by the user A is completed. When the button Bt2 is selected, after the machine translation process requested by the user A is completed, the translation management unit 23 transmits a completion notification to the user B that the machine translation requested by the user A is completed. After transmitting the completion notification, the translation management unit 23 receives the user B's access right request.

### Modification 2: Confidentiality Level of Document is Displayed

The translation management unit 23 may obtain confidentiality levels of translations. The obtained confidentiality levels may be used for purposes described below.

First, based on the confidentiality levels, the translation management unit 23 may set a version or versions the user B can access with the access right. This may increase the security.

The translation management unit 23 may notify the user B of the confidentiality level.

With the configurations of the document management system 1 and the document management server 20 described above, an access right of a user may be taken into consideration, and the user may be able to avoid translating the same document a plurality of times. As a result, the storage space of the document management server 20 may be saved, and the processing resources may also be saved. Moreover, in the case where the user is paying for the translation service by the translation server 30, translation cost may also be saved.

In the case where the user has an access right to a previous translation of a document and the user is trying to translate the document with the same settings as the previous settings that were used to obtain the previous translation, the document management server 20 provides the previous translation to the user, so the user may be provided with a translation of the document quickly without having to wait for the document to be newly translated.

In the case where the user has an access right to the previous translation and is trying to translate the document into the same language as the previous translation but with settings different from the previous settings that were used to obtain the previous translation, the document management server 20 transmits to the user a notification indicating this situation, so that the user is informed of the presence of the previous translation, even though the previous settings that were used to obtain the previous translation are different from the user's desirable settings. This notification may be useful when the user does not care too much about translation settings as long as the user is provided with a translation in his/her desired language.

In the case where the user does not have an access right to the previous document, the user may request the access right and be given the access right upon approval of the request.

Furthermore, with the configurations of the document management system 1 and the document management server 20 described above, in the case where the previous translation is revised, version management of the previous translation is performed. Specifically, a user may be given an access right to all the versions of the previous translation or only to the initial version of the previous translation. Accordingly, the user may be allowed to access all or a specific version or versions of the previous translation in accordance with the confidentiality levels of the revised versions.

Furthermore, with the configurations of the document management system 1 and the document management server 20 described above, when the translation process to obtain the previous translation is still in progress, the user is notified that the document is undergoing the translation process to obtain the previous translation. When the translation process is completed, the user receives a completion notification. This may be helpful when the user wants to avoid the document from being translated a plurality of times. The user may be able to obtain the previous translation upon completion of the previous translation if the user has a right that will allow access to the completed previous translation. Even if the user does not have such right, the user may request an access right to the previous translation.

### <Explanation for Program>

A process performed by the document management server 20 according to an exemplary embodiment described above is, for example, prepared as a program such as software. The program is implemented by cooperation between software and hardware resources.

A program for executing a process to be performed by the document management server 20 may be regarded as a program for causing a computer to implement a function for, when providing a response to a user who is trying to obtain a first translation of a document that has previously been translated to obtain a second translation, varying the response to the user in accordance with a difference between settings set by the user to obtain the first translation of the document and settings that have been used to obtain the second translation of the document.

A program for implementing an exemplary embodiment may not only be provided by communication means but also be stored in a recording medium such as a compact disc-read only memory (CD-ROM) and provided.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A document management apparatus comprising:
a processor configured to
provide a response to a user who is trying to obtain a first translation of a document,
wherein the processor is configured to vary the response to the user in a case where first settings set to obtain the first translation and second settings that have been used to obtain a second, previous translation of the document are different.

2. The document management apparatus according to claim 1, wherein the processor is configured to, in a case where the user has an access right to the second translation and the first settings and the second settings are the same, display the second translation, as the response to the user.

3. The document management apparatus according to claim 1, wherein the processor is configured to, in a case where the user has an access right to the second translation, the first setting and the second settings are different, and a target language of the first translation and a language of the second translation are the same, notifies the user of presence of the second translation, as the response to the user.

4. The document management apparatus according to claim 1, wherein the processor is configured to, in a case where the user does not have an access right to the second translation, prompt the user to request the access right, as the response.

5. The document management apparatus according to claim 4, wherein the processor is configured to
perform version management to track changes made to the second translation, and
set a version of the second translation that the user can access with the access right.

6. The document management apparatus according to claim 5, wherein the processor is configured to grant the user the access right to permit access to all versions of the second translation.

7. The document management apparatus according to claim 5, wherein the processor is configured to separate out an initial version of the second translation and grant the user the access right to only permit access to the initial version of the second translation.

8. The document management apparatus according to claim 5, wherein the processor is configured to, in a case where an initial version of the second translation is not available, notify the user of non-availability of the initial version of the second translation.

9. The document management apparatus according to claim 5, wherein the processor is configured to
obtain a confidentiality level of the second translation, and
set a version of the second translation the user can access with the access right, in accordance with the confidentiality level.

10. The document management apparatus according to claim 9, wherein the processor is configured to notify the user of the confidentiality level.

11. The document management apparatus according to claim 1, wherein the processor is configured to, in a case where the document is undergoing machine translation process to obtain the second translation when the user is trying to obtain the first translation, notify the user that the document is undergoing the machine translation process to obtain the second translation.

12. The document management apparatus according to claim 11, wherein the processor is configured to, when the machine translation process to obtain the second translation is completed, notifies the user of completion of the machine translation process to obtain the second translation.

13. The document management apparatus according to claim 12, wherein the processor is configured to, after the notification of the completion of the machine translation process to obtain the second translation, receive a request for the access right to the second translation from the user.

14. A document management system comprising:
a terminal apparatus that performs viewing of a document; and
a document management apparatus that manages the document,
wherein the document management apparatus includes a processor configured to
provide a response to a user who is trying to obtain a first translation of a document by machine translation,
wherein the processor is configured to vary the response to the user in a case where first settings set to obtain the first translation and second settings that have been used to obtain a second, previous translation of the document are different.

15. A non-transitory computer readable medium storing a program causing a computer to execute a process for document management, the process comprising:
providing a response to a user who is trying to obtain a first translation of a document by machine translation,
wherein the response to the user varies in a case where first settings set to obtain the first translation and second settings that have been used to obtain a second, previous translation of the document are different.
